(19) United States
(12) Patent Application Publication
(10) Pub. No.: US 2004/0184445 A1
(43) Pub. Date: Sep. 23, 2004

(54) Computer algorithm and method for facilitating the networking of individuals

(76) Inventor: Jeffrey K. Burne, Woodland Hills, CA (US)

Correspondence Address: ROBERT J. SCHAAP, Suite 188, 21241 Ventura Boulevard, Woodland Hills, CA, 91364, US

(21) Appl. No.: 10/803,744

(22) Filed: Mar. 17, 2004

Related U.S. Application Data
(60) Provisional application No. 60/455,998, filed on Mar. 18, 2003.

(51) Int. Cl. H04L 12/66

(52) U.S. Cl. 370/352

(57) ABSTRACT

An algorithm and method for using computer services for facilitating the meeting and communication of individuals in a social networking environment. The algorithm and method allow for individuals using differing modes of communication, for example one using voice communication and another using computer communication, to be in direct communication with one another. The algorithm and method also facilitate direct communication when one party locates a potential candidate and is desirous of being in direct communication with that candidate. Message recording and playback are also facilitated as well as other advantages arising from the use of the algorithm and software program derived therefrom as well as the method of the invention.

### RELATED APPLICATION

This application is based on and claims for priority the filing date of my provisional application Serial No. 60/455,998, filed Mar. 18, 2003, entitled Algorithm and Method for Operating a Dating Service.

### BACKGROUND OF THE INVENTION

1. Field of the Invention

An algorithm and method for operating a networking arrangement and enabling communication between parties and enabling one party to locate another from a biographical summary of that other individual and to enable communication therebetween and, more particularly, an algorithm for generating software and a method which enable web to voice integration and message recording and playback for individuals in that network.

2. Brief Description of Related Art

In recent years, networking groups have become quite popular as a means to enable people to meet one another and to engage in business activities. These meetings generally provide a structured environment for people of common interests to meet one another and to converse with one another. Such meetings of this type are useful and beneficial in both business activities and in attempts to find a casual or permanent personal relationship.

One form of these networking groups is that of a dating service in which males and females may locate a member of the opposite sex or, for that matter, the same sex, and who have the characteristics and interests which are compatible with one seeking to locate an individual. These dating services are quite common in recent years and enable people to establish either casual or permanent social relationships with one another.

Most of these conventional dating services operate with a database containing biographical information, frequently referred to as “biographical sketches” of individuals who are members of that dating service. Thus, if a male, for example, is interested in locating a female who might be of interest to him, he can examine the biographical sketches of a large number of females. If he finds one or more of those females who may be of interest to him, he can then arrange to contact them on a personal basis.

Usually, these dating services and, for that matter, the other networking groups, charge a standard fee, such as an entrance fee, which may be based on an initial payment or otherwise a periodic payment as, for example, a monthly payment. In this case, each individual who wishes to be a member of the networking group and,. particularly, the dating service, must pay the standard fee in order to be able to access the database containing the biographical sketches of other potential individuals. In many cases, the application or entrance fee can be substantial and this thereby militates against many individuals joining the dating service who might otherwise be inclined to join that service. The same holds true with other forms of networking groups.

One of the disadvantages of many of the conventional networking groups is that there is the unavailability to enable different forms of communication. As a simple example, one member may wish to communicate via e-mail over the Internet and another may wish to use voice mail. In essentially all standard and commercially available networking groups, this type of communication where one uses one form of communication and another party uses a different form of communication is not available. In addition, and in many cases, there are individuals who would like to network with one another but may be prohibited from doing so because of language barriers. Thus, because of the language barriers, they may choose not to even entertain the possibility of a networking group.

Another one of the standard disadvantages of most networking groups is the fact that they do not provide for messages and paging independently of the phone company or a message answering machine used by one or both of the individuals. It would be desirable, however, to provide a networking facility organization which allows for both message recording and paging of an individual. It would also be desirable to provide a networking group which provides for various forms of communication simultaneously.

### OBJECTS OF THE INVENTION

It is, therefore, one of the primary object of the present invention to provide an algorithm which enables a method of communication for permitting the networking of individuals.

It is another object of the present invention to provide an algorithm of the type stated which enables communication of individuals forming part of a networking group with differing modes of communication and differing communication links.

It is a further object of the present invention to provide a method enabling algorithm of the type stated which also allows for recording of messages and playback of messages through a networking computer program which permits voice communication and World Wide Web communication.

It is an additional object of the present invention to provide a method enabling algorithm which allows for chatroom services or private communication between two or more individuals.

It is another salient object of the present invention to provide a method of enabling a networking of individuals in such manner which is highly effective, enabling one individual to select an individual of choice and to communicate with that individual of choice.

It is still another object of the present invention to provide a method of the type stated which allows individuals to communicate with one another and which is relatively easy to use and which is based on costs only when services are used.

With the above and other objects in view, my invention resides in the novel features of form, construction, arrangement and combination of steps and procedures presently described and pointed out in the claims.

### SUMMARY OF THE INVENTION

The present invention is based on a method enabling algorithm which allows for a networking and, more particularly, a communication between individuals who may or may not be a member of the networking group. The method enabling algorithm has many advantages which are not available in any prior art networking communication algorithm and the method achieved thereby.

The term “networking” is used with reference to groups of individuals in such manner that it enables the individuals to learn about one another and to become in contact with one another, usually through voice communication or e-mail communication. In this sense, the networking will cover such aspects as dating groups in which both males and females can learn about and potentially meet one another. This algorithm of the invention is also effective to allow business individuals, whether male or female, to also learn about capabilities and occupations of others in order to enable communication between one another.

The present invention is therefore described in terms of a dating network and is a network in which members of the opposite sex and, for that matter, members of the same sex can meet one another and establish dating relationships and even permanent relationships therefrom. However, it is to be understood that the present invention is not so limited and can be used for a variety of networking groups.

The algorithm of the present invention has several unique features which are not available in the prior art and those features are shown largely and schematically by reference to FIG. 1 of the drawings which is hereinafter discussed in more detail. However, it can be observed that there are several features available which are not a part of any existing communication network.

One of the unique features of the present invention is the fact that there is a database of individuals containing biographical information about those individuals. A party can select any one or more of those individuals and attempt to communicate with those individuals, either by voice or e-mail using the World Wide Web. In this case, the invention provides for a communication between the parties, even though the modes of communication are entirely different. The networking algorithm allows for translation of e-mail and conversion to voice and also for conversion of voice to e-mail and presentation of e-mail to the opposite party.

In addition to the foregoing, the present invention allows for recording of a message and playback of that message. Although message recording and playback is customary in many individuals homes and office environments, it is not standard in networking groups. The present invention provides precisely for that service independently of any phone system.

The algorithm of the invention also allows for direct private communications between two or more individual who may or may not be members of the networking group. In this respect, the communications are not limited only to members of the networking group and this thereby provides a wide degree of individuals who can be contacted by members of the networking group. There is also provided direct member communication, as indicated, as well as a chatroom in which a group of individuals can communicate with one another.

In addition to the foregoing, and to enable use of a system based only on the services assumed, the members of the networking group will pay, largely based on the services provided. Thus, for example, if the cost of operating the group is based on the amount of time individuals spend in direct communication or in a chatroom environment, that cost can be automatically associated with the individual member receiving the same and accumulated within a bill or deducted from credits established by that individual. In this way, there is not necessarily a need for an entrance fee and other fees associated with networking groups.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a schematic block diagram showing some of the major functions achieved with the algorithm of the present invention;

FIG. 2 is a schematic block diagram showing the initial steps accomplished in the method enabling algorithm of the invention;

FIG. 3 is a more detailed schematic block diagram which commences at the termination of the steps in FIG. 2; and

FIG. 4 is a schematic block diagram showing certain routines forming part of the algorithm of the present invention.

### DETAILED DESCRIPTION OF A PREFERRED EMBODIMENT

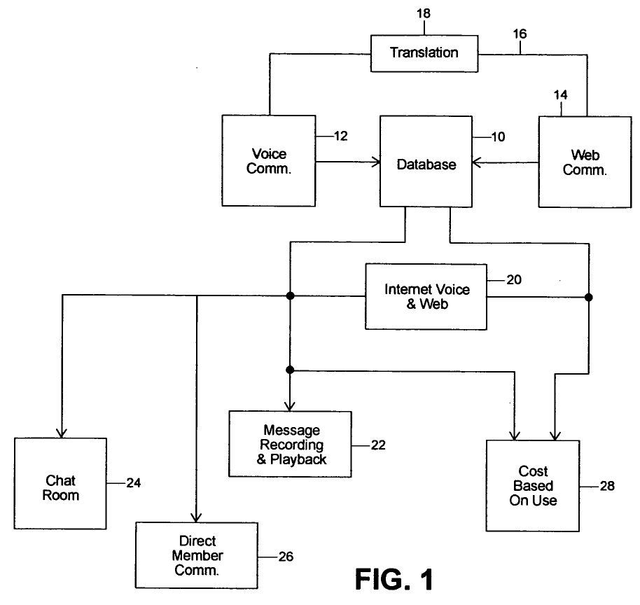

Referring now in more detail and by reference characters to the drawings which illustrate practical embodiments of the present invention, FIG. 1, in particular, shows a schematic block diagram which generally outlines some of the major functions achieved with the algorithm of the present invention.

More particularly, the algorithm of the present invention is a method enabling algorithm, that is it enables the accomplishment of a method which allows for communication between two or more individuals in a networking arrangement. In particular, the algorithm uses a main database 10 which contains information, such as biographical information, about each of the individuals forming part of the networking group. This database may contain, for example, the individuals names, ages, race, dating preferences and related biographical information about an individual that they would seek to meet, such as a member of the opposite sex and the age range of that member, the occupational status and other biographical data. All of this information would be contained in the database 10.

The algorithm of the present invention is unique in that it allows for a voice communication shown at 12 and a web communication shown at 14. In this way, each can communicate with the database. Moreover, each can communicate individually with one another over a communication link 16 in which there is provided a translating service 18. This translating service includes several steps as hereinafter described and allows for communication between one using only voice communication, e.g. a telephone, and the other using only web communication, such as e-mail and the like.

The invention further includes communication with both voice and web over the Internet. It also allows for enabling direct communication between the voice communication 12 and the web communication 14.

The invention further allows for the leaving of a message and the playback of a message at 22. Thus, one member attempting to contact an individual can attempt to leave a message such that that individual can return the communication of the calling party. In connection therewith, a chatroom 24 is also provided in which several individuals may all communicate directly and at the same time, in the same manner as if they were in a room together. In this way, there is at least the availability of private messaging and the ability to communicate with a number of individuals directly. It can be seen that there is also direct member communication 26 which provides for private communication.

As indicated previously, one of the features of the invention is the cost based on the use of the system. In this way, there may not be a need for an initial cost to join the networking group and this is shown at 28. In this case, as the member uses services which are provided by the networking group, they can pay only for those services. Thus, the cost will be based only upon use and not upon the privilege of merely being a member.

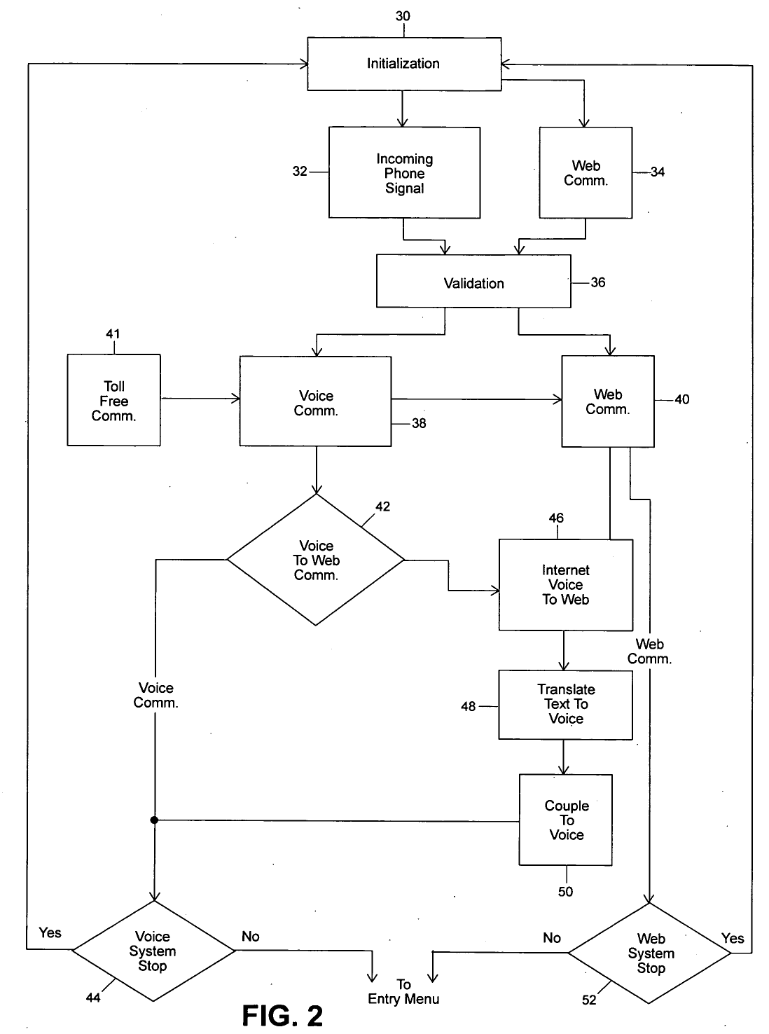

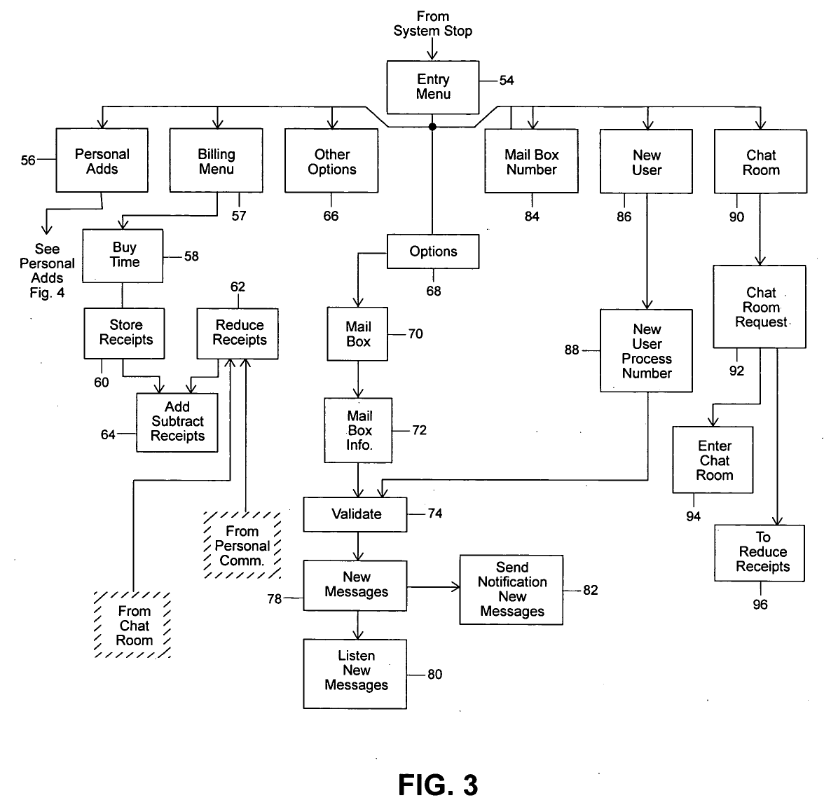

Referring now to FIGS. 2 and 3, the major steps forming part of the algorithm of the invention are shown. In particular, the algorithm starts with an initialization step 30 which initializes the system and enables the system to be operating. In some measures, since the system can be operated 24 hours a day, 7 days a week, with little or no downtime, initialization may be a rare activity.

After initialization of the system, the system itself is adapted to receive an incoming phone signal at 32 and it is also adapted to receive a web communication signal at step 34. In this case, the incoming phone signal would occur via a conventional telephone system communication line. The web communication would occur usually over the World Wide Web and a signal will appear in the form of an e-mail at a central station operated by the networking group. At this central station, if the operator or, for that matter, an electronic device detects the need for Internet communication with voice communication, such will be established. Thus, if one member using voice communication is attempting to communicate with another member using only e-mail communication, that communication will be facilitated, all in a manner as hereinafter described in more detail.

Initially, a validation step takes place in which there is an attempt to determine whether the individuals attempting to contact one another via the networking group are valid individuals with valid attempts to communicate. Thus, if one user attempts to introduce information into a mailbox of another user, a validation step 36 will automatically take place and determine if the party desiring to leave information in a mailbox is a member entitled to do so. Otherwise, the party attempting to leave a message has a message which is rejected. In this way, members are insulated from prank callers and callers attempting to leave obscene messages.

After validation, and where one individual is attempting to use voice communication at step 38 and another is attempting to use web communication at step 40, that communication can be enabled with each individual still using their own mode of communication. For this purpose, there is a decision step 42 determining whether there is a web communication or a voice communication. If there is a voice communication, then the decision will be directed to a voice system mode of communication at 44. If there is to be a web communication, then messages are directed to the Internet voice to web system at step 46. Thereafter, an operator for the networking service translates the text from the web at step 48 to a voice signal. In like manner, the same operator can receive the voice to text signal and convert same to an e-mail message for the party using the e-mail communication system. In this way, communication is enabled. Where voice communication and e-mail communication are still used, the voice signal is coupled with the e-mail system at step 50 and which permits the translation at step 48.

A toll free communication may also be available in accordance with the system of the invention at step 41. Either this toll free communication may adopt the form of simply providing a toll free number that a user can employ or, otherwise, it can be a toll free telephone service in which a user at a remote location can access a member at a particular city and with the costs thereof assumed by the networking service provider.

If there is to be true web communication only, a decision is made at step 52 in which the system will stop in one case, and will continue to an entry menu 54, as hereinafter described. In each case, the voice system can stop and the web system will stop which causes the voice signal and the e-mail signal to be returned to initialization. Otherwise, the system allows one to proceed to operation of the entry menu 54.

The use of the combination of voice and web communication has several significant advantages. The first advantage is that there is enabled a complete live communication between two or more individuals. Secondly, this communication is conducted privately, but only with the assist of an operator in which there is still complete confidentiality. Thirdly, there is the ability to record messages as, for example, in a mailbox or to enable a live communication as stated above. There is also the same ability to retrieve those messages. In each case, conversion of an e-mail to a voice message could be also a synthesized voice. Thus, by using a voice synthesizer, the electronic signals which generate the e-mail message can also be used to operate a speech synthesizer which allows speech to be generated automatically.

One of the advantages of the system of the present invention is that there is also both voicemail and e-mail translation services available. For example, one individual attempting to communicate with another individual using another different language, such that one individual uses English and the other individual uses Spanish, the system can employ individual live operators who can also operate to automatically translate between those types of languages. Thus, an individual speaking Spanish will enable the operator to convert that to English and relay the English language message to the party speaking English and vice versa. All of this is accomplished through the networking service and independently of outside sources.

One of the advantages of this type of system, which is not necessarily available in the prior art, is the fact that individuals who do not wish to receive prank or obscene messages or otherwise insincere messages can isolate themselves from such occurrences. In other words, the system can be arranged so that only members of the networking group can leave messages for another member of the networking group. This will clearly reduce the number of calls which are undesirable and, moreover, this is particularly advantageous for females who do not wish to be subjected to phone calls which are deemed to be undesirable.

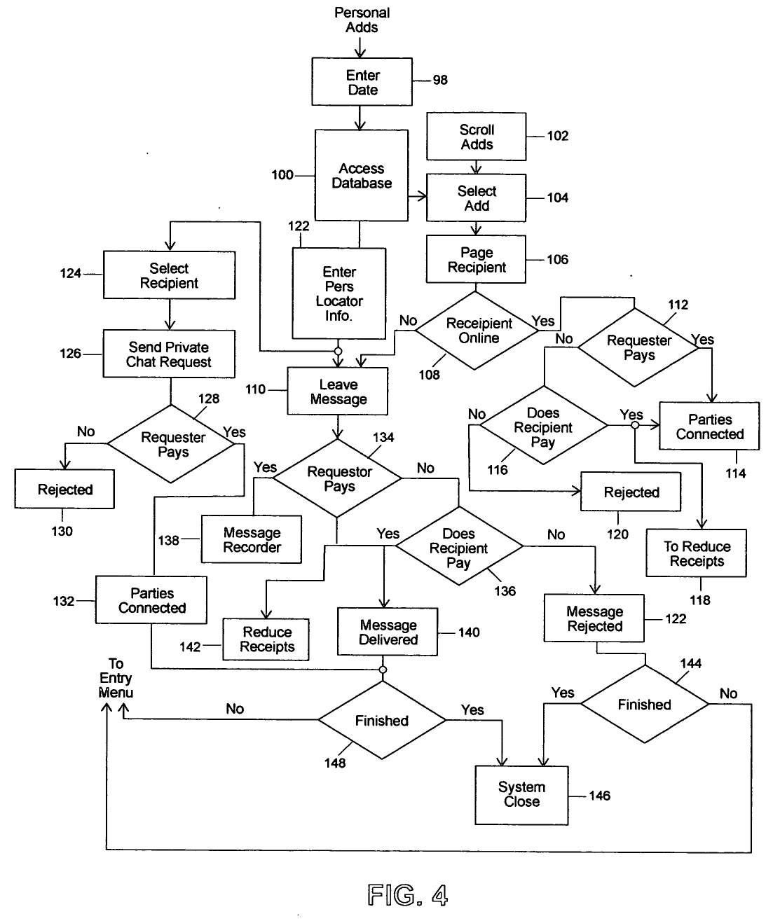

After the entry menu has been displayed at step 54, various options are available. An individual can merely leave a personal ad at step 56. Thus, an individual may leave another selected individual information about the caller. The routine for personal ads is more fully shown in FIG. 4 and is hereinafter described in more detail.

There is also a billing menu at step 57. Inasmuch as the system is a so-called “pay as you go” system, the user, such as the member of the networking group, is billed only for actual time used on the system or for services which are rendered by the networking group. Under the billing menu, a particular member can buy time and store that time at step 58. The time which is purchased is then identified as receipts which are stored at step 60.

When a party using the system takes advantage of services provided or uses time, either in a chatroom environment or as a direct means of communication, the receipts will be automatically reduced at step 62. Those receipts can be recorded and displayed to the user at step 64. Thus, and for example, it can be observed that receipts will be reduced based on the use of personal communication with another member of the networking group and based on use of the chatroom. The party using that system can then elect to purchase more time in the same manner as previously described.

The algorithm of the invention also allows for other options at step 66. Thus, for example, additional options which allow certain functions to take place can also be added by the networking service organization or, otherwise, they can be added for particular individuals. This may be advantageous for individuals who are handicapped but who wish to take advantage of the networking services which are available. In this way, the networking service can be partially tailored to accommodate the needs of each of the networking members. This is a feature which is not necessarily available in other networking groups in which all individuals are treated homogeneously as a group.

The algorithm of the invention provides various communication options at step 68. Thus, one may open a mailbox at step 70 and introduce information into that mailbox at step 72. Otherwise, the user of the mailbox can access messages which may have been left in that mailbox. Obviously, the mailbox is a recording of e-mail messages or otherwise voice messages. In each case, the user can access those messages at the user's option using either e-mail communication or voice communication.

Validation of messages which are to be left in the mailbox can be accomplished at step 76. As a simple example, anyone attempting to leave a message in a mailbox may be required to be a member. Thus, for example, only a member may be allowed to leave a message and if the member does not provide a membership number or code or the like then the message would be rejected. In this way, it is also possible to locate members who may be abusing the system by leaving messages which are inappropriate.

At this point in time, and assuming the messages are validated and the messages recorded, the new messages are recorded at step 78. The user can listen to those new messages at his or her option at step 80. Moreover, the system can be adapted to send notification of new messages at step 82. Thus, for example, when a message is left, a voice signal can be generated and recorded on an answering machine of a networking member advising of the presence of a new message. In like manner, an e-mail presence signal can also be generated at step 82.

The algorithm of the invention also includes a step 84 for establishing a new mailbox number. In actuality, several steps may be employed here, as in connection with other routines. In this case, the user may be required to pay a fee if the networking organization so elects and, in any event, a mailbox may be issued as well as a code, such as a personal identification code, to enable use of that mailbox. There is provided a new user routine 86 which allows for a new user to establish the mailbox. In this case, the new user is given a processing number, such as a personal identification number, at step 88. At this point, when a message is desired to be left or, for that matter, desire to be accessed, it is possible to validate the user who is attempting to leave or access the message. Thus, only the user of that mailbox is entitled to access any messages in that mailbox.

One of the important features of the present invention which is not available in substantially all prior art networking algorithms, is the availability of a chatroom, shown as step 90. This chatroom does not necessarily enable personal direct communication with members but, rather, it makes available communication with a number of individuals who may wish to join in a conversation with one another as though they were sitting in the same facility at the same time. In this case, and assuming that a member wishes to participate in the chatroom, the user can generate a chatroom request at step 92. Again, this request can be generated via voice communication, such as over a telephone, or it can be generated by e-mail. To the extent that the individual is a member, he or she may then join in communication in that chatroom.

If the individual joins the chatroom, that individual would be allowed to enter at step 94. However, one of the modes of generating revenue for the networking service provider may be based on the use of this system such that the user would pay for that availability at step 96. In this case, it can be observed that receipts in the members personal account would be reduced at step 62.

As indicated previously, a personal advertisement (ad) routine is more fully set forth in FIG. 4 of the drawings. In this case, for purposes of understanding this personal ad routine, it may be assumed that the networking service provider charges for services when they are used as, for example, by virtue of charging for the personal communications between individuals or use or a chatroom or the like.

In order to provide a personal ad, or to even access a personal ad, a user can enter a date at step 98. This may allow the user to access the database at step 100. Thereafter, the user can scroll ads at step 102 and select an ad of the user's choice at step 104. As indicted previously, those ads will contain a biographical sketch of the member and the user can thereafter determine if he or she is interested in that individual based on the biographical sketch. In like manner, photographs and other information can also be presented in that personal ad.

One of the unique facets of the present invention is the fact that the networking service provider can then arrange for paging of the recipient at step 106. In this case, the recipient may be online and actually accessing information as well about other networking group members. Otherwise, the member who is sought may be involved in the chatroom. In this way, a page can be generated to that individual who is being sought. If that individual is not already involved in the chatroom or otherwise online to locate and scroll ads, then a message can be left in the manner as previously described.

The use of the paging system is highly effective in that many members will attempt to either enter a chatroom or otherwise scroll ads in evening hours after their working day. Moreover, they may actually elect to be online waiting for potential contacts from other networking group members. This is particularly true for new members. In either case, the networking service provider does provide for the paging of that member.

When a page is generated, a determination is made at step 108 to determine whether or not the recipient of the message is online. If the recipient is not online, the member can leave a message at step 110. If the recipient is online, a communication can then be established assuming that either the caller or the recipient pays the required charge to the networking service provider. A decision is then made at step 112 to determine whether the requester or party seeking to contact another has elected to pay for that communication. If the requester has elected to pay, the parties are connected at step 114. If the requester has not elected to pay, a determination is made at step 116 to determine whether the recipient of the message will pay. If the recipient of the message will pay, the parties are connected at step 114 and, in addition, depending on who has agreed to pay, receipts are reduced from that account at step 118. Thus, if the requester has agreed to pay, the cost will be deducted automatically from his or her account and if the recipient has agreed to pay then the cost will be deducted from his or her account at step 118. If the recipient elects not to pay and the requester has not agreed to pay then the message is rejected at step 120.

When a party wishes to leave information, as indicated at step 100, or when the party wishes to access information, they may introduce personal locator information at step 122. At that point, the party looking for locator information, that is biographical information about another member, can select that recipient member at step 124. The party wishing to contact, e.g. the requester, can contact that individual, either by a private communication or a chat request, at step 126. Again, inasmuch as the system in this example is based on cost for services used, a determination is made at step 128 whether the requestor will pay. If the requestor does not agree to pay he or she is rejected at step 130. If that requestor does agree to pay, then parties are connected at step 132.

When a message is left at step 110, again, there is a determination for basis of payment at step 134. If the requestor who wishes to leave a message does not pay, a determination is made whether or not the recipient will pay at step 136. If the requester does agree to pay, then the message will be recorded at step 138. However, if the requestor does not agree to pay at step 134, a determination is made at step 136 to determine whether the recipient will pay. If the recipient does pay then the message can be delivered at step 140. Moreover, credits are reduced from that recipient's account at step 142. If the recipient does not pay, the message is rejected at step 122. A determination is made as to whether or not the communication channel is finished at step 144. If the communication is finished, then the system will close at step 146. In like manner, if a message is delivered at step 140, a determination is also again made at step 148 as to whether or not communication is finished. If communication is finished the system will close and, if not, then a return to the entry will be made as shown in FIG. 4 of the drawings.

One of the advantages of the system as described herein, in the preferred embodiment, is the fact that messages may be listened to free of charge if desired and may be scrolled free of charge if elected by the networking service provider. This is highly advantageous for younger individuals who cannot otherwise afford a flat fee, such as an annual fee. In this way, a type of pay as you go system is established which may be more amenable for the younger users. One of the advantages of the system of the invention is that it offers a different membership base than other systems and which allows members to connect with one another wherever they may be located. Moreover, to the extent that the networking service provider provides for toll free long distance calling, the geographic area for the individual members is actually broadened.

One of the unique features, as indicated previously, is the fact that the system can be customized to accommodate a particular individual. For this purpose, numerous templates can be developed by the user to actually take into consideration many options which may be requested by one or more users.

Thus, there has been illustrated and described a unique and novel computer algorithm and method for facilitating the networking of individuals and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what I desire to claim and secure by Letters Patent is:

1. A method enabling algorithm for enabling a networking of people with differing communication links, said method enabling algorithm comprising:
a) receiving either of a telephone communication or an e-mail communication from first individual attempting to contact a second individual who is a member of a group of networking people;
b) establishing an e-mail communication link with the second individual to communicate with the first individual;
c) providing a voice translation of a message the second individual presents over the e-mail;
d) sending the translation of the e-mail message via voice to the first individual;
e) converting voice messages from the first individual to an e-mail translation; and
f) sending the translation of the voice message to the second individual.

2. The method enabling algorithm for enabling a networking of people with differing communication links of claim 1 further characterized in that the networking comprises enabling people to meet one another on a personal social basis.

3. The method enabling algorithm of claim 2 further characterized in that said algorithm comprises:
steps for enabling individuals to access a database containing biographies of other individual members of a group of networking people.

4. The method enabling algorithm of claim 1 further characterized in that cost for using a networking group of the networking people is based on certain uses arising out of use of the algorithm.

5. The method enabling algorithm of claim 4 further characterized in that said method enabling algorithm comprises:
steps to validate message delivery.

6. A method enabling algorithm for enabling a networking of people which allows for private communication or separately group communication, said method enabling algorithm comprising:
a) accessing a communication by an individual in a networking group of such individuals who is desirous of meeting and contacting other individuals of said networking group;
b) determining from said communication if the individual initiating the communication is desirous of a private communication or a communication with individuals of a group of such individuals simultaneously; and
c) causing initiation of communication with the individual initiating the communication with the group if so selected by the initiating individual.

7. The method enabling algorithm for enabling a networking of people of claim 6 further characterized in that said method enabling algorithm comprises:
attempting to initiate a private communication between the initiating individual and a selected recipient individual of the group if so elected by the initiating individual and not with the group of individuals.

8. The method enabling algorithm of claim 7 further characterized in that said method enabling algorithm comprises:
validating the initiating individual if the latter seeks a private communication.

9. The method enabling algorithm of claim 7 further characterized in that said method enabling algorithm comprises:
a) attempting to initiate said private communication relies upon a sending of a page to the selected recipient member of the group; and
b) establishing the private communication if the selected recipient member responds to the page.

10. The method enabling algorithm of claim 6 further characterized in that said method enabling algorithm further comprises:
automatically accessing and crediting an account of one of the initiating individuals or the selected recipient individual if the communication therebetween is allowed to proceed.

11. The method enabling algorithm of claim 6 further characterized in that said method enabling algorithm further comprises:
giving to the selected recipient individual the opportunity to pay for said private communication if the initiating individual elects not to pay.
